(19) United States
(12) Patent Application Publication
(10) Pub. No.: US 2019/0263385 A1
(43) Pub. Date: Aug. 29, 2019

(54) TORQUE CONTROL DURING GEAR SHIFTS FOR AN ELECTRICALLY ALL-WHEEL DRIVE HYBRID VEHICLE

(71) Applicant: Yuxing Zhou, Sterling Heights, MI (US)

(72) Inventor: Yuxing Zhou, Sterling Heights, MI (US)

(21) Appl. No.: 15/905,153

(22) Filed: Feb. 26, 2018

(51) Int. Cl. B60W 20/19; B60W 10/06; B60W 10/08; B60W 10/119; B60W 20/30; B60W 10/11

(52) U.S. Cl. CPC B60W 20/19; B60W 2510/1005; B60W 10/08; B60W 10/119; B60W 20/30; B60W 10/11; B60W 2520/30; B60W 2540/10; B60W 2540/12; B60W 2710/0666; B60W 2710/083; Y10S 903/945; Y10S 903/93; B60W 2710/1005; B60W 10/06

(57) ABSTRACT

Control systems and methods for an electrically all-wheel drive (eAWD) hybrid vehicle utilize an input device/sensor configured to receive an operating parameter of the hybrid vehicle, the operating parameter relating to whether to perform a gear shift of a transmission, the transmission being configured to transfer drive torque from a first torque generating unit to only a first axle of the hybrid vehicle, and a controller configured to, based on the measured operating parameter, determine whether to perform a gear shift of the transmission, and while performing the gear shift of the transmission, control a second torque generating unit to compensate for a disturbance caused by the gear shift, the second torque generating unit being configured to provide drive torque to only a different second axle of the hybrid vehicle.

### FIELD

The present application generally relates to hybrid vehicles and, more particularly, to techniques for torque control during a gear shift for an electrically all-wheel drive (eAWD) hybrid vehicle.

### BACKGROUND

Vehicles include a torque generating unit (e.g., an internal combustion engine) that generates drive torque. This drive torque is typically transferred to an axle of the vehicle via a transmission (e.g., an automatic transmission). The axle is rotatably coupled to wheels/tires of the vehicle, which transfer the drive torque from the axle to a road surface. Clutch-to-clutch gear shifts of the transmission often cause a disturbance at the axle, such as a temporary torque reduction and/or a delayed torque response. This disturbance could be noticeable to a driver of the vehicle. Accordingly, while such vehicle drive systems work for their intended purpose, there remains a need for improvement in the relevant art.

### SUMMARY

According to one aspect of the invention, a control system for an electrically all-wheel drive (eAWD) hybrid vehicle is presented. In one exemplary implementation, the control system comprises: an input device/sensor configured to receive an operating parameter of the hybrid vehicle, the operating parameter relating to whether to perform a gear shift of a transmission, the transmission being configured to transfer drive torque from a first torque generating unit to only a first axle of the hybrid vehicle, and a controller configured to: receive, from the input device/sensor, the measured operating parameter; based on the measured operating parameter, determine whether to perform a gear shift of the transmission; and while performing the gear shift of the transmission, control a second torque generating unit to compensate for a disturbance caused by the gear shift, the second torque generating unit being configured to provide drive torque to only a different second axle of the hybrid vehicle.

In some embodiments, (i) the transmission and the first torque generating unit and (ii) the second torque generating unit are independent such that the first and second axles only interact with each other via respective wheels/tires and a ground surface. In some embodiments, the first axle is a front axle of the hybrid vehicle and the second axle is a rear axle of the hybrid vehicle. In some embodiments, the first torque generating unit is an internal combustion engine and the second torque generating unit is an electric motor. In some embodiments, the transmission is one of a multiple-ratio transmission, an automatic transmission, and a dual clutch transmission.

In some embodiments, the controller is configured to control the second torque generating unit to temporarily increase the drive torque provided to the second axle to compensate for the disturbance while performing the gear shift. In some embodiments, the disturbance is a temporary reduction of the drive torque at the first axle to less than a desired drive torque corresponding to a driver torque request. In some embodiments, the disturbance is a delayed response in the drive torque at the first axle increasing to a desired drive torque corresponding to a driver torque request.

According to another example aspect of the invention, a method of performing a gear shift of a transmission of an electrically all-wheel drive (eAWD) hybrid vehicle is presented. In one exemplary implementation, the method comprises: receiving, by a controller and from an input device/sensor, a measured operating parameter of the hybrid vehicle, the operating parameter relating to whether to perform a gear shift of a transmission, the transmission being configured to transfer drive torque from a first torque generating unit to only a first axle of the hybrid vehicle; based on the measured operating parameter, determining, by the controller, whether to perform a gear shift of the transmission; and while performing the gear shift of the transmission, controlling, by the controller, a second torque generating unit to compensate for a disturbance caused by the gear shift, the second torque generating unit being configured to provide drive torque to only a different second axle of the hybrid vehicle.

In some embodiments, (i) the transmission and the first torque generating unit and (ii) the second torque generating unit are independent such that the first and second axles only interact with each other via respective wheels/tires and a ground surface. In some embodiments, the first axle is a front axle of the hybrid vehicle and the second axle is a rear axle of the hybrid vehicle. In some embodiments, the method further comprises determining, by the controller, a driver demanded wheel torque based on accelerator and brake pedal input and vehicle speed, wherein a sum of wheel torques at the first and second axles meets the driver demanded wheel torque.

In some embodiments, the method further comprises calculating, by the controller, the wheel torques at the first and second axles in real-time. In some embodiments, the wheel torque at the first axle is a difference between (i) a product of engine flywheel torque and transmission torque ratio and (ii) transmission torque loss. In some embodiments, the transmission torque ratio is a product of (i) a torque converter torque ratio calculated based on a torque converter slip ratio and a characterized factor, (ii) a real-time calculated gearbox torque ratio, and (iii) a fixed final gear ratio. In some embodiments, the wheel torque at the second axle is a product of (i) the drive torque generated by the second torque generating device and (ii) a fixed second axle gear ratio.

In some embodiments, the controlling of the second torque generating unit is performed to temporarily increase the drive torque provided to the second axle to compensate for the disturbance while performing the gear shift. In some embodiments, the disturbance is a temporary reduction of the drive torque at the first axle to less than a desired drive torque corresponding to a driver torque request. In some embodiments, the disturbance is a delayed response in the drive torque at the first axle increasing to a desired drive torque corresponding to a driver torque request. In some embodiments, the first torque generating unit is an internal combustion engine and the second torque generating unit is an electric motor.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 illustrates a first example electrically all-wheel (eAWD) drive hybrid vehicle according to the principles of the present disclosure;

FIG. 2 illustrates a second example eAWD hybrid vehicle according to the principles of the present disclosure;

FIG. 3 illustrates an example plot of torque control during a gear shift for an eAWD hybrid vehicle according to the principles of the present disclosure; and

FIG. 4 illustrates an example flow diagram of a method of performing a gear shift of a transmission of an eAWD hybrid vehicle according to the principles of the present disclosure.

### DETAILED DESCRIPTION

As previously discussed, clutch-to-clutch gear shifts of transmissions often cause disturbance at an axle of the vehicle, such as a temporary torque reduction and/or a delayed torque response, which could be noticeable to a driver of the vehicle. Accordingly, techniques are presented for compensating for this disturbance in hybrid vehicles having electric all-wheel drive (eAWD) capabilities. These hybrid vehicles typically include independent torque generating units for the front and rear axles. The only connection between these torque generating units is via the wheels/tires and the ground surface. When a clutch-to-clutch gear shift of a transmission connected between a first axle and a first torque generating unit (e.g., an internal combustion engine) is being performed, a second torque generating unit (e.g., an electric motor) connected to a different second axle is controlled to compensate for the disturbance at the axle as a result of the gear shift.

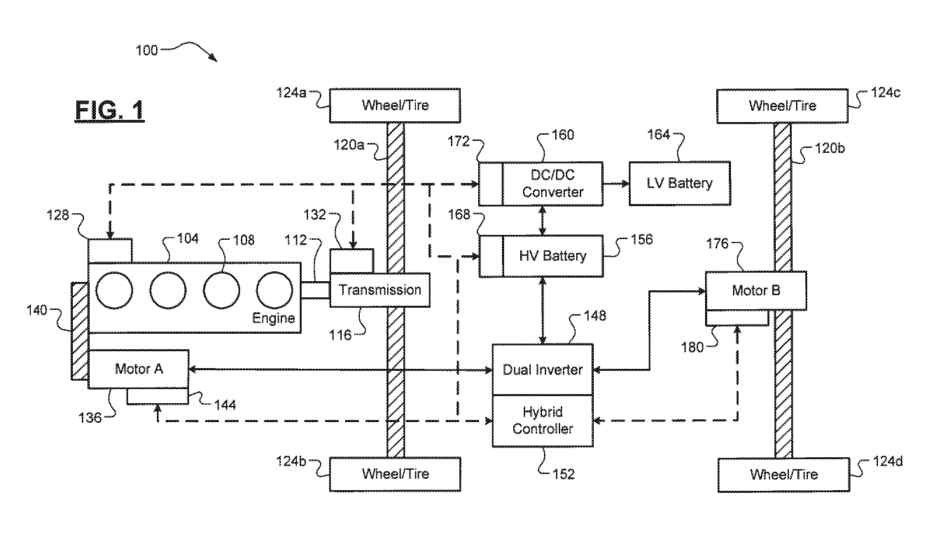

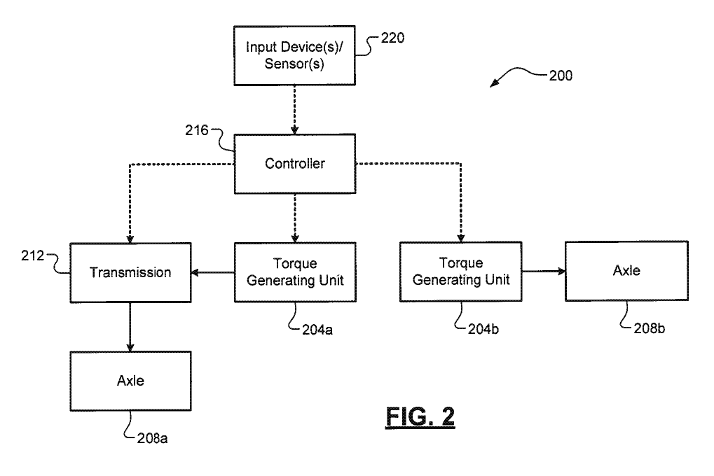

Referring now to FIG. 1, one exemplary configuration of an eAWD hybrid vehicle 100 is illustrated. It will be appreciated that this is merely one example vehicle configuration (see, e.g., FIG. 2 for a more generic configuration). The vehicle 100 includes an internal combustion engine 104 that is configured to combust a mixture of air and fuel within cylinders 108 to drive pistons (not shown) that generate drive torque at a crankshaft 112. While only four cylinders are shown, it will be appreciated that the engine 104 could include any suitable number of cylinders. The drive torque at the crankshaft 112 is transferred by a transmission 116 to a front axle 120a of the vehicle 100. The front axle 120a is in turn connected to front wheels/tires 124a, 124b. The engine 104 is controlled by a respective control unit/module 128, and the transmission 116 is controlled by a respective control unit/module 132.

The engine 104 also includes a belt-driven starter generator (BSG) unit including an electric motor 136 (“Motor A”) and a drive device 140 (e.g., a belt or chain) that couples the electric motor 136 to the crankshaft 112. The electric motor 136 is capable of acting both as a torque provider by providing torque to the crankshaft 112 (e.g., to start the engine 104) and a torque consumer by converting a portion of the drive torque at the crankshaft 112 into electrical energy. The electric motor 136 is controlled by a respective control unit/module 144. The electric motor 136 either receives electrical energy from or provides electrical energy to a dual inverter 148. The duel inverter 148 is controlled by a respective hybrid controller 152.

This hybrid controller 152 also communicates with the other control modules/units such that the vehicle 100 generates a desired drive torque, e.g., based on a driver torque request. The dual inverter 148 is also connected to a high voltage (HV) battery 156. The dual inverter 148 converts alternating current (AC) (to/from the electric motor 136) into direct current (DC) (to/from the HV battery 156 and vice-versa. The HV battery 156 is connected to a DC-DC converter 160, which steps-down a voltage of the HV battery 156 to recharge a low voltage (LV) battery (e.g., a 12 volt lead-acid battery). The HV battery is controlled by a respective control unit/module 168 and the DC-DC converter 160 is controlled by a respective control unit/module 172, both of which are also in communication with the hybrid controller 152.

The vehicle 100 further includes another electric motor 176 (“Motor B”). This electric motor 176 is also referred to as a traction motor because it provides drive torque to a rear axle 120b, which is in turn connected to rear wheels/tires 124c, 124d. It will be appreciated that the term “axle” as used herein includes a solid axle, half shafts, or any other suitable axle configuration. It will also be appreciated that the front and rear axles 120a, 120b could have the same axle configuration or different axle configurations. The electric motor 176 receives electrical energy (AC) from the dual inverter 148 in order to generate this drive torque. The electric motor 176 is controlled by a respective control module/unit 180, which is also in communication with the hybrid controller 152. During clutch-to-clutch gear shifts of the transmission 116, the drive torque at the front axle 120a temporarily drops or is delayed from reaching a desired drive torque. The techniques of this disclosure control the electric motor 176 to compensate for this torque disturbance during transmission gear shifts.

Referring now to FIG. 2, another exemplary configuration of an eAWD hybrid vehicle 200 is illustrated. As previously mentioned, the techniques disclosed herein are applicable to any vehicle having independent torque generating devices associated with the two axles of a vehicle, with at least one of the torque generating devices having a transmission that causes a torque disturbance during clutch-to-clutch gear shifts. The vehicle 200 includes a first torque generating unit 204a that is configured to generate drive torque. In one exemplary implementation, the first torque generating unit 204a is an internal combustion engine. It will be appreciated, however, that the first torque generating unit 204a could also be another suitable type of torque generating unit, such as an electric motor.

The drive torque generated by the first torque generating unit 204a is transferred to a first axle 208a of the vehicle 200 via a transmission 212. The first axle could be either a front or a rear axle of the vehicle 200. Non-limiting examples of the transmission 212 include a multi-ratio transmission, such as an electrically-variable transmission (EVT), an automatic transmission (AT), and a dual clutch transmission (DCT). The transmission 212 includes a system of clutches (not shown) and one or more planetary gear sets (not shown) that are collectively operable to achieve a desired gear ratio. Torque at an input shaft (not shown) of the transmission 212 is multiplied by this gear ratio to achieve a final output torque at an output shaft (not shown) of the transmission 212, which is provided to the first axle 208a. The transmission 212 may further comprise a torque converter (not shown) (e.g., a fluid coupling) for selectively coupling an output shaft of the first torque generating unit 204a to the input/turbine shaft of the transmission 212.

A second torque generating unit 204b is also configured to generate drive torque. In one exemplary implementation, the second torque generating unit 204b is an electric motor that generates the drive torque using electrical energy (e.g., from a battery system, not shown). It will be appreciated, however, that the second torque generating unit 204b could also be another suitable type of torque generating unit, such as an engine. The drive torque generated by the second torque generating unit 204b is provided directly to a second axle 208b of the vehicle 200. While not shown, it will be appreciated that an intermediary device, such as a transmission, could be implemented between the second torque generating unit 204b and the second axle 208b.

A control system or controller 216 controls operating of the vehicle 200. This includes, for example, controlling the first and second torque generating units 204a, 204b such that a desired drive torque is collectively provided to the first and second axles 208a, 208b. This desired drive torque is based on one or more measured operating parameters from input device(s)/sensor(s) 220. Non-limiting examples of this input device(s)/sensor(s) 220 include an accelerator pedal, a brake pedal, and/or respective pedal sensors. It will be appreciated that the desired drive torque could also be based on other operating parameters, such as vehicle speed and engine speed. The controller 216 also determines when a gear shift of the transmission 212 is to be performed.

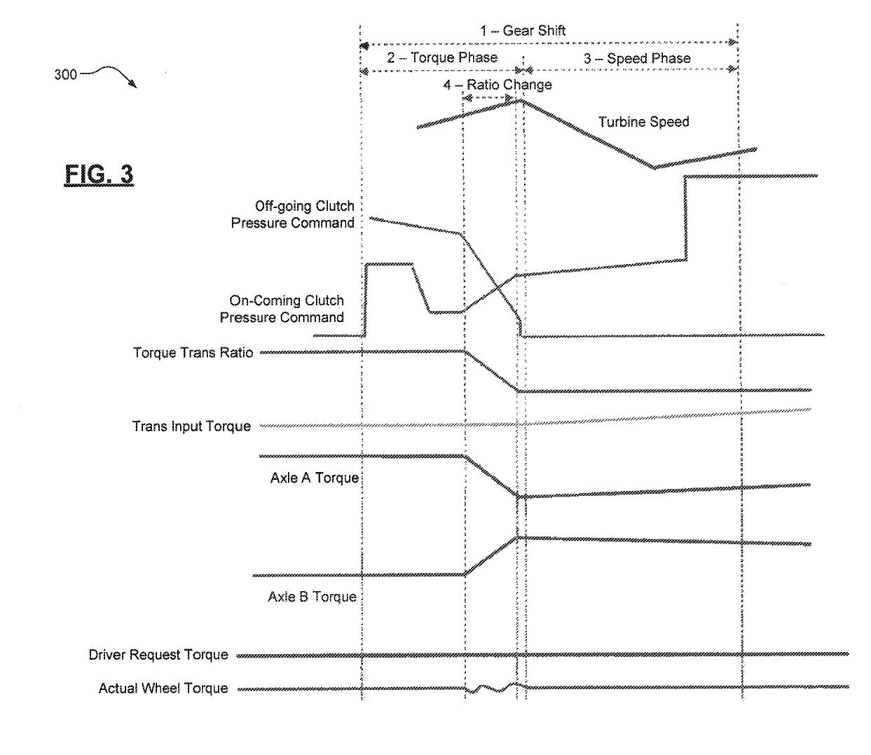

Referring now to FIG. 3, a plot 300 illustrates an example clutch-to-clutch gear shift, the torque disturbance resulting therefrom, and the compensation for the torque disturbance according to the techniques of the present disclosure. Examples of this disturbance include temporary torque reduction from a desired drive torque at the first axle 208a (e.g., an upshift) and a delayed torque response in increasing to the desired drive torque at the first axle 208a (e.g., a downshift). For example, wheel torque could decrease because of the gear ratio change in a clutch-to-clutch power-on upshift. During a power-on downshift, on the other hand, there could be a response time due to the synchronization of shaft speeds in the transmission 212. Additionally, there is a torque loss because of clutch slip control during clutch-to-clutch gear shifts. As shown in FIG. 3, the gear shift (1) comprises two phases: a torque phase (2) followed by a speed phase (3).

During an initial portion the torque phase (2), the on-coming clutch pressure is commanded to build or increase and the off-going clutch pressure beings to decrease. During a latter portion of the torque phase (2), the off-going clutch pressure is commanded to decrease as the on-coming clutch pressure is commanded to ramp up, thereby performing the gear shift and changing the gear ratio (4). Shaft speed synchronization (e.g., torque converter turbine speed matching) is then performed during the speed phase until the on-coming clutch pressure is commanded to increase to a full amount. As shown, the torque ratio of the transmission 212 drops as a result of this gear shift, as does the torque at the first axle 208a. To compensate for this torque disturbance, the second torque generating unit 204b is commanded to increase the torque at the second axle 208b. As a result, the actual wheel torque is kept approximately constant during the gear shift, which is expected by the driver's requested torque.

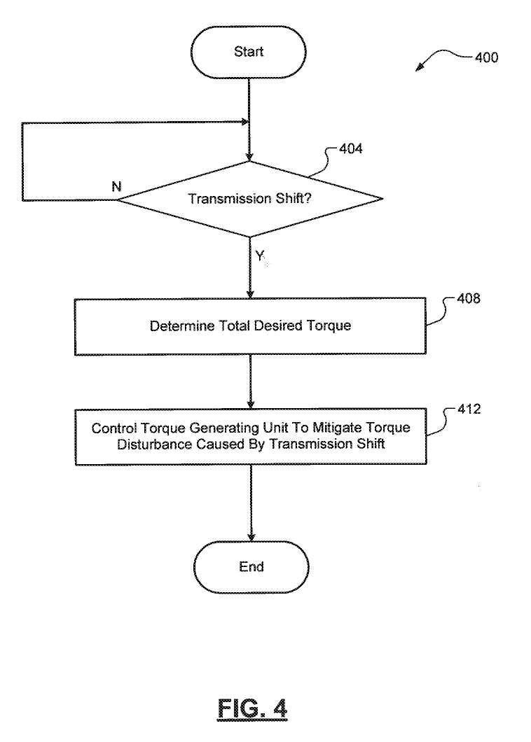

Referring now to FIG. 4, an example flow diagram of a method 400 of performing a gear shift of a transmission of an eAWD hybrid vehicle is illustrated. For illustrative purposes, the elements of FIG. 2 will be referred to hereafter. At 404, the controller 216 determines where a gear shift of the transmission 212 is imminent or is being performed. This could be based, for example, on one or more operating parameters of the hybrid vehicle 200 (driver torque request, engine speed, vehicle speed, etc.). If true, the method 400 proceeds to 408. During the gear shift, the controller 216 determines a total desired torque based on the driver torque request. This total desired torque is in the wheel domain (wheel torque) and is determined, for example, based on inputs from accelerator and brake pedals 220 and a speed of the vehicle 200. The sum of the wheel torques at the first and second axles 208a, 208b should meet the driver demanded wheel torque. In some embodiments, the wheel torques at the first and second axles 208a, 208b are calculated in real-time.

The wheel torque at the first axle 208a is a difference between (i) a product of engine flywheel torque and transmission torque ratio and (ii) transmission torque loss. The transmission torque loss is a product of (i) a torque converter torque ratio calculated based on a torque converter slip ratio and a characterized factor, (ii) a real-time calculated gearbox torque ratio, and (iii) a fixed final gear ratio. The wheel torque at the second axle is a product of (i) the drive torque generated by the second torque generating device and (ii) a fixed second axle gear ratio. Based on this total desired wheel torque, the controller 216 is configured to determine how much torque needs to be generated by the second torque generating unit 204b to account for the torque disturbance causes by the gear shift at the first axle 208a. At 412, the controller 216 then controls the second torque generating unit 204b to increase its torque output (the drive torque at the second axle 208b) to compensate for this torque disturbance at the first axle 208a. The method 400 then ends or returns to 404 for another cycle (e.g., for a subsequent gear shift).

As previously mentioned herein, it will be appreciated that the term “controller” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A control system for an electrically all-wheel drive (eAWD) hybrid vehicle, the control system comprising:
an input device/sensor configured to receive an operating parameter of the hybrid vehicle, the operating parameter relating to whether to perform a gear shift of a transmission, the transmission being configured to transfer drive torque from a first torque generating unit to only a first axle of the hybrid vehicle; and
a controller configured to:
receive, from the input device/sensor, the measured operating parameter;
based on the measured operating parameter, determine whether to perform a gear shift of the transmission; and
while performing the gear shift of the transmission, control a second torque generating unit to compensate for a disturbance caused by the gear shift, the second torque generating unit being configured to provide drive torque to only a different second axle of the hybrid vehicle.

2. The control system of claim 1, wherein (i) the transmission and the first torque generating unit and (ii) the second torque generating unit are independent such that the first and second axles only interact with each other via respective wheels/tires and a ground surface.

3. The control system of claim 2, wherein the first axle is a front axle of the hybrid vehicle and the second axle is a rear axle of the hybrid vehicle.

4. The control system of claim 1, wherein the controller is configured to control the second torque generating unit to temporarily increase the drive torque provided to the second axle to compensate for the disturbance while performing the gear shift.

5. The control system of claim 4, wherein the disturbance is a temporary reduction of the drive torque at the first axle to less than a desired drive torque corresponding to a driver torque request.

6. The control system of claim 4, wherein the disturbance is a delayed response in the drive torque at the first axle increasing to a desired drive torque corresponding to a driver torque request.

7. The control system of claim 1, wherein the first torque generating unit is an internal combustion engine and the second torque generating unit is an electric motor.

8. The control system of claim 1, wherein the transmission is one of a multiple-ratio transmission, an automatic transmission, and a dual clutch transmission.

9. A method of performing a gear shift of a transmission of an electrically all-wheel drive (eAWD) hybrid vehicle, the method comprising:
receiving, by a controller and from an input device/sensor, a measured operating parameter of the hybrid vehicle, the operating parameter relating to whether to perform a gear shift of a transmission, the transmission being configured to transfer drive torque from a first torque generating unit to only a first axle of the hybrid vehicle;
based on the measured operating parameter, determining, by the controller, whether to perform a gear shift of the transmission; and
while performing the gear shift of the transmission, controlling, by the controller, a second torque generating unit to compensate for a disturbance caused by the gear shift, the second torque generating unit being configured to provide drive torque to only a different second axle of the hybrid vehicle.

10. The method of claim 9, wherein (i) the transmission and the first torque generating unit and (ii) the second torque generating unit are independent such that the first and second axles only interact with each other via respective wheels/tires and a ground surface.

11. The method of claim 10, wherein the first axle is a front axle of the hybrid vehicle and the second axle is a rear axle of the hybrid vehicle.

12. The method of claim 9, further comprising determining, by the controller, a driver demanded wheel torque based on accelerator and brake pedal input and vehicle speed, wherein a sum of wheel torques at the first and second axles meets the driver demanded wheel torque.

13. The method of claim 12, further comprising calculating, by the controller, the wheel torques at the first and second axles in real-time.

14. The method of claim 13, wherein the wheel torque at the first axle is a difference between (i) a product of engine flywheel torque and transmission torque ratio and (ii) transmission torque loss.

15. The method of claim 14, wherein the transmission torque ratio is a product of (i) a torque converter torque ratio calculated based on a torque converter slip ratio and a characterized factor, (ii) a real-time calculated gearbox torque ratio, and (iii) a fixed final gear ratio.

16. The method of claim 13, wherein the wheel torque at the second axle is a product of (i) the drive torque generated by the second torque generating device and (ii) a fixed second axle gear ratio.

17. The method of claim 9, wherein the controlling of the second torque generating unit is performed to temporarily increase the drive torque provided to the second axle to compensate for the disturbance while performing the gear shift.

18. The method of claim 17, wherein the disturbance is a temporary reduction of the drive torque at the first axle to less than a desired drive torque corresponding to a driver torque request.

19. The method of claim 17, wherein the disturbance is a delayed response in the drive torque at the first axle increasing to a desired drive torque corresponding to a driver torque request.

20. The method of claim 9, wherein the first torque generating unit is an internal combustion engine and the second torque generating unit is an electric motor.
